(19) United States
(12) Patent Application Publication
(10) Pub. No.: US 2023/0169382 A1
(43) Pub. Date: Jun. 1, 2023

(54) SYSTEM AND METHOD OF BOSONIC QUBITS SIMULATION

(71) Applicant: XANADU QUANTUM TECHNOLOGIES INC., Toronto (CA)

(72) Inventors: Joseph Eli BOURASSA, Toronto (CA); Nicolas QUESADA, Toronto (CA); Ilan TZITRIN, Vaughan (CA); Krishnakumar SABAPATHY, Lisle (CA); Guillaume DAUPHINAIS, North York (CA); Ish DHAND, Ulm (DE)

(21) Appl. No.: 17/889,900

(22) Filed: Aug. 17, 2022

Related U.S. Application Data
(60) Provisional application No. 63/234,321, filed on Aug. 18, 2021.

(51) Int. Cl. G06N 10/20

(52) U.S. Cl. CPC G06N 10/20

(57) ABSTRACT

A method for simulating a bosonic quantum bit (qubit) on a classical computer are described. The method determines a phase space representation of the qubit in the form of a linear combination of Gaussian functions, each of which is characterized by a mean, a covariance matrix, and a weight coefficient determined from user defined energy parameter and qubit class of the qubit. The qubit may be simulated on a classical computer by applying transformations of quantum logic gates and measurements to update the weight coefficient, mean, and covariance matrix of each of the Gaussian functions.

### RELATED APPLICATIONS

This claims the benefit of U.S. Provisional Patent Application No. 63/234,321, filed on Aug. 18, 2021, the contents of which are incorporated herein by reference in their entirety.

### TECHNICAL FIELD

The present application relates to performing the simulation of quantum systems, in particular to methods and systems for simulating bosonic quantum bits (qubits) on classical computers.

### BACKGROUND

Continuous Variable (CV) quantum systems are one of the leading platforms for building a scalable fault tolerant quantum computer. Common CV systems rely on encoding qubits, the basic units of quantum information in the form of a two-level quantum system, into the states of CV systems via so-called bosonic qubits. Bosonic qubits are especially favourable for quantum computing because of their ability to correct physical errors within the CV space due to loss, random displacements, and rotations. Three classes of bosonic qubits are of primary interest, the Gottesman-Kitaev-Preskill (GKP) states, cat states, and Fock states.

Studying the performance of bosonic qubits under realistic gates and measurements is challenging with existing analytical and numerical tools on classical computers. While concrete quantum computing architectures based on bosonic qubits have been proposed, the analysis and simulation of these qubits are challenging at least because of the infinite-dimensionality in Hilbert space that they occupy. This impedes the development and implementation of existing architectures since determining fault-tolerance thresholds and overheads is limited by the ability to simulate these physical systems in realistic situations.

Presently, the most flexible method of simulating bosonic qubits relies on the Fock basis. In dealing with the infinite-dimensionality, the vector space dimension must be truncated. The boundary of truncation may also be referred to as a cut-off. Simulations in the Fock basis can be cumbersome, especially for CV states with large energies. In particular, simulation of high-quality and therefore high-energy cat and GKP bosonic qubits require a high photon-number cutoff, thereby incurring large memory loads and processing times. Moreover, determining how states change under CV channels and measurements are computationally expensive in the Fock basis representation as the energy of a given state can increase significantly under paradigmatic CV transformations such as squeezing and displacements.

Accordingly, it is desirable to provide an improved method and system of simulating bosonic qubits and its analysis that are fast and accurate.

### SUMMARY OF THE INVENTION

In one aspect, there is provided a method and system of simulating classes of bosonic qubit states that can be represented as linear combinations of Gaussian functions in phase space. This may permit analysis and simulation of a wide class of non-Gaussian states, transformations and measurements. For example, GKP, cat, and Fock state bosonic qubits can be simulated in a fast and accurate manner, allowing further investigation into the behaviour of bosonic qubits under Gaussian channels and measurements, non-Gaussian transformations such as those achieved via gate teleportation, and important non-Gaussian measurements such as threshold and photon-number detection.

According to a first example aspect, there is provided a method for simulating a quantum bit (qubit) on a classical computer, the method comprising: obtaining, by the classical computer, an energy parameter and a qubit class of the qubit to be simulated; determining, by the classical computer from the energy parameter and the qubit class, a mean, a covariance matrix, and a weight coefficient for each of at least one Gaussian function in phase space, wherein a linear combination of the at least one Gaussian function is a phase space representation of the qubit to be simulated; simulating the linear combination of the at least one Gaussian function by applying transformations of quantum logic gates and measurements to update the weight coefficient, mean, and covariance matrix of each of the at least one Gaussian function; and storing the updated weight coefficient, mean, and covariance matrix of each of the at least one Gaussian function on the classical computer.

According to a second example aspect, there is provided a method of simulating a multi-mode quantum state on a classical computer, the method comprising: obtaining, by the classical computer, an energy parameter and a qubit class of each mode of the multi-mode quantum state to be simulated; initializing, by the classical computer from the energy parameter and the qubit class, a mean, covariance matrix, and a weight coefficient of at least one first Gaussian function of each mode in phase space, wherein a linear combination of the at least one first Gaussian function is a phase space representation of a mode of the multi-mode quantum state; combining the weight coefficient, mean, and covariance matrix of the at least one first Gaussian function of each mode into weight coefficients, means, and covariance matrices of at least one second Gaussian function, wherein a linear combination of the at least one second Gaussian function is a phase space representation of the multi-mode quantum system; simulating the multi-mode quantum system by updating the weight coefficients, means, and covariance matrices of the at least one second Gaussian function by applying transformations of quantum logic gates and measurements expressed in phase space; and storing the updated weight coefficients, means, and covariance matrices of the at least one second Gaussian function of the multi-mode quantum system on the classical computer.

According to a third example aspect, there is provided a system for simulating a quantum bit (qubit) on a classical computer, the system comprises: a Gaussian function constructor configured to determine, using inputs of an energy parameter and a qubit class, a mean, a covariance matrix, and a weight coefficient for each of at least one Gaussian function in phase space, wherein a linear combination of the one Gaussian function is the phase space representation of the qubit to be simulated; and a Gaussian function transformer configured to simulate the qubit by applying transformations of quantum logic gates and measurements to the linear combination of the at least one Gaussian function on the classical computer, thereby updating the weight coefficient, mean, and covariance matrix of each of the at least one Gaussian function.

According to a fourth example aspect, there is provided a non-transitory machine-readable medium having tangibly stored thereon executable instructions for execution by a processor of a classical computer, wherein the executable instructions, when executed by the processor, cause the classical computer to: obtain, by the classical computer, an energy parameter and a qubit class of the qubit to be simulated; determine, by the classical computer from the energy parameter and the qubit class, a mean, a covariance matrix, and a weight coefficient for each of at least one Gaussian function in phase space, wherein a linear combination of the at least one Gaussian function is a phase space representation of the qubit to be simulated; simulate the linear combination of the at least one Gaussian function by applying transformations of quantum logic gates and measurements to update the weight coefficient, mean, and covariance matrix of each of the at least one Gaussian function; and store the updated weight coefficient, mean, and covariance matrix of each of the at least one Gaussian function on the classical computer.

In any of the above aspects, the qubit may be a bosonic qubit.

In any of the above aspects, the qubit class may include Gottesman-Kitaev-Preskill (GKP) state, cat state, and Fock state.

Any of the above aspects may further comprise constructing a Wigner function of the qubit from the updated weight coefficient, mean, and covariance matrix of each of the linear combination of the Gaussian functions.

Any of the above aspects may further comprise sampling outcomes of the linear combination of the at least one Gaussian function.

In any of the above aspects, the linear combination of Gaussian functions may be of the form:

$$W ( ξ ; \hat{ρ} ) = {c}_{m} {G}_{{μ}_{m} {Σ}_{m}} ( ξ )$$

wherein W is a Wigner function of the of the qubit, [symbol] is the set of indices enumerating the Gaussian functions, ζ∈ [symbol] ²ⁿ is a phase space variable for an n-mode continuous variable (CV) quantum system, \hat{ρ} is a density matrix operator in Hilbert space that is representative of the energy parameter and the qubit class of the qubit, cₘ is the weight coefficient, μₘ is the mean, and Σₘ is the covariance matrix, and G is a normalized multivariate Gaussian distribution function.

In any of the above aspects, when the qubit class is a GKP state, the obtaining may further comprise receiving a GKP state representation.

In any of the above aspects, when the GKP state representation is a real-valued GKP state, the weight coefficient, mean, and covariance matrix of each of the at least one Gaussian function may be determined by:

$${c}_{m} ( ϵ ; θ , ϕ ) = exp [ - \frac{1 - {e}^{2 ϵ}}{ℏ ( 1 + {e}^{- 21 ϵ} )} {μ}_{m}^{T} {μ}_{m} ] ; \\ {μ}_{m} ( ϵ ) = \frac{2 {e}^{- ϵ}}{1 + {e}^{- 2 ϵ} )} {μ}_{m} ; and \\ {Σ}_{m} ( ϵ ) = \frac{ℏ}{2} \frac{1 - {e}^{- 2 ϵ}}{( 1 + {e}^{- 2 ϵ} )} ;$$

Where the energy parameter is specified by ∈, θ and ϕ are the polar and azimuthal angles of the qubit in the Bloch sphere representation, [symbol] is an overall normalization constant defined to satisfy a condition of as Σ_{m∈M}cₘ=1, n is Planck's constant, and [symbol] is an identity matrix.

In any of the above aspects, when the GKP representation is a complex-valued GKP state, the weight coefficient, mean, and covariant matrix of each of the at least one Gaussian function may be determined by:

$${c}_{m} = exp \{ - \frac{απ}{2} [ {( s + 2 l )}^{2} + {( t + 2 k )}^{2} ] \} \times [ \frac{{β}^{2} {π ( t + s + 2 l + sk )}^{2}}{4 α} ] ; \\ {μ}_{m} ( ϵ ) = - \frac{\sqrt{πℏ}}{2} ( \begin{matrix}\frac{( t + s + 2 l + 2 k )}{α} \\ i ( s - t + 2 l - 2 k )\end{matrix} ) ; and \\ {Σ}_{m} ( ϵ ) = \frac{ℏ}{2} ( \begin{matrix}\frac{1}{α} & 0 \\ 0 & α\end{matrix} ) , ( α , β ) = ( coth ( ϵ ) , - csch ( ϵ ) ) ;$$

Where the energy parameter is specified by ∈, [symbol] ={m≡(k, l, s, t)|s, t ∈ {0,1}&k, l ∈ [symbol] }, [symbol] denotes set of all integers, αₛ is and αₜ* are derived from |ψ(α) [symbol] =α₀|0 [symbol] _{gkp}+α₁|1 [symbol] _{gkp}, [symbol] (α, ∈) is an overall normalization constant defined to satisfy the condition of [symbol] =1, n is Planck's constant.

In any of the above aspects, when the GKP representation is a squeezed comb state, the weight coefficient, mean, and covariant matrix of each of the at least one Gaussian function may be determined by:

$$= \{ m ≡ ( k , l ) \vert k , l ∈ 1 … , d \} , \\ {μ}_{m} = \frac{1}{2} ( {\overline{q}}_{k} + {\overline{q}}_{l} , i {ϵ}^{2 r} [ {\overline{q}}_{k} - {\overline{q}}_{l} ] ) , \\ {Σ}_{m} = \frac{ℏ}{2} [ \begin{matrix}{e}^{- 2 r} & 0 \\ 0 & {e}^{2 r}\end{matrix} ] \\ {e}_{m} = exp ( - \frac{1}{4 ℏ} {{e}^{2 r} ( {\overline{q}}_{k} - {\overline{q}}_{l} )}^{2} ) .$$

Where [symbol] is a normalization constant, qₙ are the locations of the peaks in the position quadrature where

$${\overline{q}}_{n} = - ( N + 1 ) \frac{d}{2} + nd ,$$

and N is me number of peaks in the comb.

In any of the above aspects, when the qubit class is a cat state, the weight coefficient, mean, and covariant matrix of each of the at least one Gaussian function may be determined by:

$${C}_{\pm } = , {c}_{z} = {( {c}_{\overline{z}} )}^{*} = {e}^{- i π k - 2 {\vert α \vert}^{2}} ; \\ {μ}_{\pm } = \pm \sqrt{2 ℏ} ( ( α ) , ( α ) ) , \\ {μ}_{z} = {( {μ}_{\overline{z}} )}^{*} = \sqrt{2 ℏ} ( i ( α ) , - i ( α ) , ) ; and \\ {Σ}_{vac} = \frac{ℏ}{2} .$$

Wherein the energy parameter is specified by α, +, −, [symbol] , Z̅ are indices for the Gaussian functions in phase space corresponding to the four terms from the cat state density matrix such that [symbol] ={+, −, [symbol] , Z}, [symbol] is an overall normalization constant defined to satisfy the condition of [symbol] (∈; θ, ϕ)=1, n is Planck's constant, and [symbol] is an identity matrix.

In any of the above aspects, when the qubit class is a Fock state, the weight coefficient, mean, and covariant matrix of each of the at least one Gaussian function may be determined by:

$${c}_{m} = ( \begin{matrix}n \\ m\end{matrix} ) [ \frac{1 - {nr}^{2}}{1 - ( n - m ) {r}^{2}} ] ; \\ {μ}_{m} = 0 ; and \\ {Σ}_{m} = \frac{ℏ}{2} \frac{1 + ( n - m ) {r}^{2}}{1 - ( n - m ) {r}^{2}} ;$$

Wherein the energy parameter is specified by n, [symbol] ={0, . . . , n}, r is a parameter quantifying the quality of the approximation, [symbol] is the index fro reach Gaussian function, [symbol] ₙ is an overall normalization constant defined as

$$= \frac{n ! ( n ( \frac{- {r}^{2} - 1}{{r}^{2}} ) ! + ( - \frac{1}{{r}^{2}} ) ! )}{( \frac{{nr}^{2} - 1}{{r}^{2}} ) !} ,$$

n is Planck's constant, and [symbol] is an identity matrix.

In any of the above aspects, the combining may further comprise recursively combining the weight coefficient, mean, and covariance matrix of the at least one first Gaussian function into the weight coefficients, means, and covariance matrices of the at least one second Gaussian function of the multi-mode quantum system.

In any of the above aspects, when the qubit class is GKP state or cat state, the initializing may further comprise initializing one covariance matrix for the at least one first Gaussian function.

In any of the above aspects, the combining may further comprise: combining the weight coefficients as a product of two weight coefficients; combining the means as a direct sum of two means; and combining the covariance matrix as a direct sum of two covariance matrices.

In any of the above aspects, the linear combination of the at least one first Gaussian function and the linear combination of the at least one second Gaussian function may be of the form:

$$W ( ξ ; \hat{ρ} ) = {c}_{m} {G}_{{μ}_{m} {Σ}_{m}} ( ξ )$$

wherein W is a Wigner function of the of the qubit, [symbol] is the set of indices enumerating the Gaussian functions, ζ∈ [symbol] ²ⁿ is a phase space variable for an n-mode continuous variable (CV) quantum system, \hat{ρ} is a density matrix operator in Hilbert space that is representative of the energy parameter and the qubit class of the qubit, cₘ is the weight coefficient, μₘ is the mean, and Σₘ is the covariance matrix, and G is a normalized multivariate Gaussian distribution function.

In any of the above aspects, the Gaussian function constructor may be further configured to determine the linear combination of the at least one Gaussian function in phase space of the form:

$$W ( ξ ; \hat{ρ} ) = {c}_{m} {G}_{{μ}_{m} {Σ}_{m}} ( ξ )$$

wherein W is a Wigner function of the of the qubit, [symbol] is the set of indices enumerating the Gaussian functions, ζ∈ [symbol] ²ⁿ is a phase space variable for an n-mode continuous variable (CV) quantum system, \hat{ρ} is a density matrix operator in Hilbert space that is representative of the energy parameter and the qubit class of the qubit, cₘ is the weight coefficient, μₘ is the mean, and Σₘ is the covariance matrix, and G is a normalized multivariate Gaussian distribution function.

### BRIEF DESCRIPTION OF THE DRAWINGS

Reference will now be made, by way of example, to the accompanying figures which show example embodiments of the present application, and in which:

FIG. 1 illustrates a simplified block diagram of a classical computing system, which may be used to implement exemplary embodiments;

FIG. 2 illustrates a flowchart of a method for simulating a qubit on a classical computer as shown in FIG. 1 in accordance with one exemplary aspect of the present disclosure;

FIG. 3 illustrates a partial graphical representation of an exemplary GKP state qubit in phase space;

FIG. 4 illustrates a graphical representation of the Wigner function of a cat state being expressed as a linear combination of four Gaussian functions in phase space in accordance with exemplary aspects of the present disclosure;

FIG. 5 illustrates a flowchart of a simulation method for simulating a multi-mode quantum system in accordance with the present disclosure;

FIG. 6 illustrates comparison of the simulation results of two cat states simulated in Fock basis and Gaussian representation, respectively, sent through a lossy beam-splitter;

FIG. 7 illustrates comparison of simulation results of a high-energy GKP state in Fock basis and Gaussian representation, respectively; and

FIG. 8 illustrates a simplified block diagram of a simulator system for simulating qubits on a classical computer in accordance with exemplary embodiments of the present disclosure

Like reference numerals are used throughout the Figures to denote similar elements and features. While aspects of the invention will be described in conjunction with the illustrated embodiments, it will be understood that it is not intended to limit the invention to such embodiments.

### DETAILED DESCRIPTION OF EXAMPLE EMBODIMENTS

### Exemplary Computing System

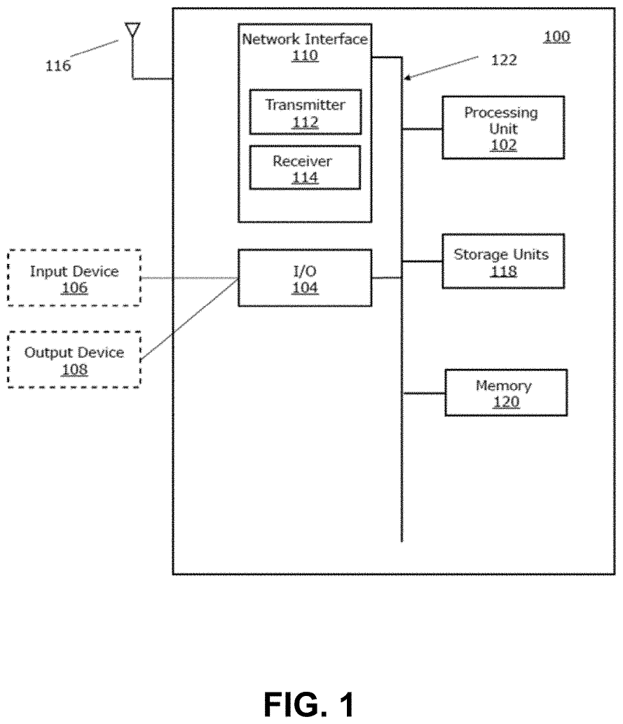

FIG. 1 illustrates a simplified block diagram of a classical computing system 100, which may be used to implement methods and systems described herein. Other computing systems suitable for implementing the methods and systems described in the present disclosure may be used, which may include components different from those discussed below. In some example embodiments, the computing system 100 may be implemented across more than one physical hardware unit, such as in a parallel computing, distributed computing, virtual server, or cloud computing configuration. Although FIG. 1 shows a single instance of each component, there may be multiple instances of each component in the classical computing system 100.

The classical computing system 100 may include one or more processing unit(s) 102, such as a central processing unit (CPU) with a hardware accelerator, a graphics processing unit (GPU), a tensor processing unit (TPU), a neural processing unit (NPU), a microprocessor, an application-specific integrated circuit (ASIC), a field-programmable gate array (FPGA), a dedicated logic circuitry, a dedicated artificial intelligence processor unit, or combinations thereof.

The classical computing system 100 may also include one or more input/output (I/O) interfaces 104, which may enable interfacing with one or more appropriate input devices 106 and/or output devices 108. In the example shown, the input device(s) 106 (e.g., a keyboard, a mouse, a microphone, a touchscreen, and/or a keypad) and output device(s) 108 (e.g., a display, a speaker and/or a printer) are shown as optional and external to the computing system 100. In other examples, one or more of the input device(s) 106 and/or the output device(s) 108 may be included as a component of the computing system 100. In other examples, there may not be any input device(s) 106 and output device(s) 108, in which case the I/O interface(s) 104 may not be needed.

The classical computing system 100 may include one or more network interfaces 110 for wired or wireless communication with a network. In example embodiments, network interfaces 110 include one or more wireless interfaces such as transmitters 112 that enable communications in a network. The network interface(s) 110 may include interfaces for wired links (e.g., Ethernet cable) and/or wireless links (e.g., one or more radio frequency links) for intra-network and/or inter-network communications. The network interface(s) 110 may provide wireless communication via one or more transmitters 112 or transmitting antennas, one or more receivers 114 or receiving antennas, and various signal processing hardware and software. In this regard, some network interface(s) 110 may include respective processing systems that are similar to classical computing system 100. In this example, a single antenna 116 is shown, which may serve as both transmitting and receiving antenna. However, in other examples there may be separate antennas for transmitting and receiving.

The classical computing system 100 may also include one or more storage devices such as storage units 118, which may include a non-transitory storage unit such as a solid state drive, a hard disk drive, a magnetic disk drive and/or an optical disk drive. The storage devices of computing system 100 may include one or more memories 120, which may include a volatile or non-volatile memory (e.g., a flash memory, a random access memory (RAM), and/or a read-only memory (ROM)). The storage devices (e.g., storage units 118 and/or non-transitory memory(ies) 120) may store instructions for execution by the processing units(s) 102, such as to carry out the present disclosure. The memory(ies) 120 may include other software instructions, such as for implementing an operating system or a quantum simulation system as disclosed herein and other applications/functions.

In some examples, one or more data sets and/or module(s) may be provided by an external memory (e.g., an external drive in wired or wireless communication with the classical computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 122 providing communication among components of the classical computing system 100, including the processing units(s) 102, I/O interface(s) 104, network interface(s) 110, storage unit(s) 118, memory(ies) 120. The bus 122 may be any suitable bus architecture including, for example, a memory bus, a peripheral bus or a video bus.

In one aspect, the present disclosure provides a method and system for simulating a class of CV states, transformations, and measurements using linear combinations of Gaussian functions in phase space. This framework may permit simulating transformations of useful bosonic qubits such as GKP, cat, and Fock states under Gaussian channels and their measurements, as well as under a class of valuable non-Gaussian channels effected through gate teleportation. To facilitate the design of quantum computing architectures, the disclosed method and system may model sources of decoherence, such as optical loss in photonics or dissipation in superconducting cavities, as well as transformations and measurements that are readily-implementable in photonics, such as linear optics, squeezing operations, homodyne and photon-counting detection. The Gaussian representation of bosonic qubits may enable fast and accurate simulation of bosonic qubits on a classical computing system. The scaling of computing system memory and processing time required for a bosonic qubit simulator in accordance with the present disclosure may be more favourable compared to current state-of-the-art Fock basis simulators.

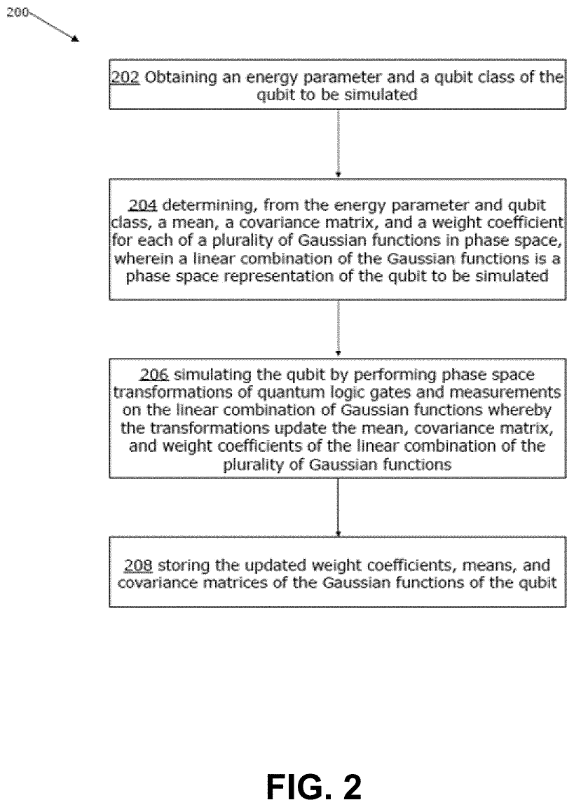

Residing in a two-dimensional subspace of the infinite-dimensional Hilbert space of a CV mode, the bosonic qubit is a robust unit for quantum computation in platforms such as photonics. Several classes of bosonic qubits, including GKP state, cat state, and Fock state, can correct errors within the CV space, adding an additional level of protection against physical noise. FIG. 2 illustrates a flowchart of a method 200 for simulating a qubit on a classical computer in accordance with one exemplary aspect of the present disclosure.

At 202, an energy parameter and a qubit class (ie. GKP, cat, Fock) of a bosonic qubit to be simulated is obtained. The energy parameter and qubit class are described in more detail below with respect each of the qubit classes. The energy parameter and qubit class may be obtained from the user through input devices 106, input files received over a network through network interface 110, or any other suitable manner. As for any quantum mechanical system, a complete description of its state can be obtained by specifying its density matrix, which, for the bosonic qubits simulatable in accordance with the present disclosure, is characterized by a qubit's energy parameter and qubit class. Derivation of energy matrix based on qubit energy parameter and qubit class is well known in the art. Thus, for simplicity, qubit energy parameter and qubit class are two equivalent ways of specifying the initial state of a bosonic qubit. However, it should be noted that the method in accordance with the present disclosure may not need to simulate or derive the energy matrix \hat{ρ}and only requires the user to specify the qubit energy parameter and qubit class.

At 204, qubit is expressed in its phase space representation as a linear combination of at least one Gaussian function in accordance with the present disclosure. Specifically, the obtained energy parameter and qubit class are used to determine a mean, a covariance matrix, and a weight coefficient for each of the at least one Gaussian function in phase space, wherein the linear combination of the at least one Gaussian function models the qubit to be simulated.

The characteristic function of a CV quantum system may then be defined as:

x(r;\hat{p})=tr(\hat{D}(r)\hat{ρ})

Where \hat{D}(r)=exp(iζ^{T}Ωr) is the Weyl or displacement operator, Ω is the symplectic form, ζ denotes the CV quadrature operators, T denotes the transpose, and r ∈ [symbol] ^{2N} is a real vector in phase-space.

As an example, the characteristic function of Gaussian states may take the form:

$$χ ( r ; \hat{ρ} ) = exp ( - \frac{1}{2} {r}^{T} Σ r - i {μ}^{T} Ω r )$$

Where μ is a vector of means and Σ is a covariance matrix of the state having density matrix \hat{ρ} with elements:

$$\text{?}$$

$$\text{?} \text{indicates text missing or illegible when filed}$$

The covariance matrix of a valid quantum state, whether or not it is a Gaussian, satisfies the uncertainty relation:

$$\text{?}$$

$$\text{?} \text{indicates text missing or illegible when filed}$$

A different characterization of Gaussian pure states can be obtained by noting that they can be prepared by applying a Gaussian unitary Û to the multimode vacuum state |0 [symbol] ^{⊗N} in the form of |ψ [symbol] _{G}=Û|0 [symbol] ^{⊗N}, where the unitary is generated by a Hamiltonian that is at most quadratic in the quadrature operations. The vacuum state is the unique state that is mapped to zero by its respective destruction operator:

$$\text{?}$$

$$\text{?} \text{indicates text missing or illegible when filed}$$

and has vector of means and covariance matrix:

$${μ}_{vac} = 0 , and {\sum }_{vac} = \frac{h}{2}$$

where [symbol] is the identity matrix.

From the above, it follows that the Wigner function representation, which is the Fourier transform of the characteristic function, is as follows:

$$\text{?}$$

$$\text{?} \text{indicates text missing or illegible when filed}$$

Accordingly, the Wigner function of a Gaussian state may be expressed as a linear combination of Gaussian function of the phase-space variable ζ. Each Gaussian function may be characterized by a mean and a covariance matrix in phase space with a weight coefficient. According to an exemplary embodiment of the present disclosure, the Wigner function of a n-mode CV state may be expressed as a linear combination of Gaussian functions in phase space in the following form:

W(ζ;\hat{ρ})= [symbol] cₘG_{μ}_{ₘ}_{Σ}_{ₘ}(ζ) Equation (1)

where [symbol] is the set of indices enumerating the Gaussian functions which can in general be multi-parametered, ζ∈ [symbol] ²ⁿ is the phase space variable for an n-mode CV system, and \hat{ρ} is the corresponding density matrix operator in Hilbert space that is representative of the energy parameter and the qubit class of the qubit. In one example embodiment, each Gaussian function in the linear combination is characterized with a weight coefficient cₘ, a mean μₘ of 2n dimensions for a n-mode CV system, and a 2nλ2n covariance matrix Σₘ. The weight coefficient, mean, and covariance matrix are, in general, complex-valued. The normalized multivariate Gaussian distribution G is defined as

$${G}_{μ , \sum } ( ξ ) = \frac{exp [ - \frac{1}{2} {( ξ - μ )}^{T} {\sum }^{- 1} ( ξ - μ ) ]}{\sqrt{det ( 2 π \sum )}} \qquad Equation ( 2 )$$

It should be noted that the weight coefficients, means and covariances may be subject to certain mathematical constraints to ensure the bosonic qubit being simulated respects physical restrictions imposed by quantum mechanics.

As disclosed herein, classes of Bosonic qubits, including GKP state, cat state, and Fock state, may be expressed in the form of Equation (1). The method of determining the initial values of weight coefficient, mean, and covariance matrix for each class of Bosonic qubits are described in more detail below.

### GKP States

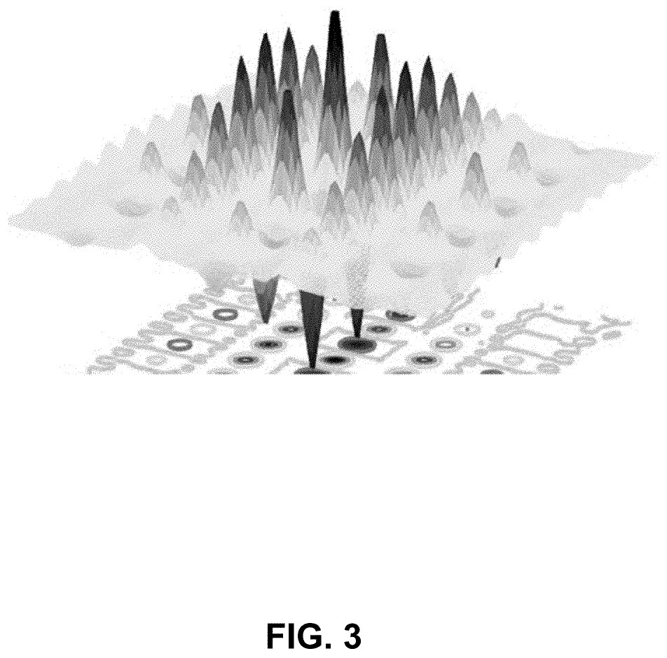

As disclosed, the GKP states are one of the bosonic qubit classes of interest in the field of quantum computing at least because of its error correction abilities. The ideal square-lattice GKP logical wavefunctions are defined as infinite number of combs of Dirac delta functions spaced by 2\sqrt{πn} in the position quadrature:

$$\text{?}$$

$$\text{?} \text{indicates text missing or illegible when filed}$$

where |· [symbol] _{q} denotes an eigenstate of the position quadrature and k denotes the logical value. A partial graphical representation of an exemplary GKP state qubit in phase space is shown in FIG. 3. Rectangular and hexagonal lattice encodings are related to the square lattice via symplectic transformations. Another advantage of the GKP encoding is that quantum logic gates, such as Clifford gates and measurements, correspond to Gaussian transformations, which are experimentally accessible in the photonics context. Pauli X and Z gates correspond to displacements by \sqrt{π}n along the q and p quadratures, respectively. The Hadamard gate is a rotation by π/2 in phase space. The qubit phase, CX, and CZ gates correspond to a CV quadratic phase, and the CX, and CZ gates, which are active Gaussian transformations, in the sense of requiring a squeezing component. Measurement-based inline squeezers may be feasibly implemented and deterministic. Pauli X and Z measurements correspond to homodyne measurements along q and p quadratures. A universal gate set can be completed with the qubit T gate; in the GKP encoding, this gate can be implemented through gate teleportation with a GKP magic state.

In accordance with the present disclosure, Gaussian functions each characterized by a weight coefficient, a mean that indicative of a phase space location of the Gaussian function, and a covariance matrix that is indicative of the shape of the Gaussian function, are used to model one or more of the delta function peaks (or combs as shown in FIG. 3) such that a linear combination of such Gaussian functions may model a GKP state qubit.

Any pure GKP state can be expressed in the Bloch sphere representation as

$$\text{?}$$

$$\text{?} \text{indicates text missing or illegible when filed}$$

The Wigner function of an ideal single-mode square-lattice GKP state can be expressed in terms of the parameters of Equation (1) as follows:

$$= \{ m ≡ ( k \sqrt{π h} / 2 , ℓ \sqrt{π h} / 2 ) \vert k , ℓϵℤ \} , \qquad Equation ( 3 )$$

$${\sum }_{m} = {lim}_{δ \to 0 +} δ , {μ}_{m} = m .$$

The weights cₘ(θ, ϕ), which encode the logical content of the state, are as given by:

$$\text{?}$$

$$\text{?} \text{indicates text missing or illegible when filed}$$

Since each Gaussian peak in the Wigner function is a function of Σₘ⁻¹, one cannot directly evaluate the above limit of covariance matrix δ→0+ in Equation (3). The Gaussian distributions for the ideal GKP Wigner function are Dirac delta functions located at the lattice points enumerated in [symbol] . This means that the ideal GKP state has infinite energy and cannot be normalized, rendering it unphysical. Hence, it is necessary to obtain a finite-energy GKP state qubit. The covariance matrices do not vary with the index and are proportional to the identity, and may be used to convert finite-energy GKP states to Gaussian functions. Note that GKP states corresponding to alternative lattice spacings, such as rectangular or hexagonal GKP states, can be related to square-lattice states by symplectic transformations in phase space, which may be applied to states that can be expressed as linear combinations of Gaussian functions in phase space. Additionally, GKP qudits correspond to a different linear combination of 6-functions in phase space. Mathematically, a Fock damping operator in the form of:

Ê(e)=e^{-eh},e>0,

where ∈ is the energy parameter of the GKP state, and \hat{n} is the photon number operator, may be applied to an ideal GKP state to derive a corresponding finite-energy GKP state with real-valued Gaussian parameters. Because Ê (c) is a single non-unitary Kraus operator, it is non-trace-preserving, meaning the normalization of the resulting states must be accounted for. The derivation showing Wigner function corresponding to the single non-unitary Kraus operator applied to an ideal GKP state can be represented in the same form as Equation (1).

Accordingly, with the set [symbol] , applying the damping function to the ideal coefficients cₘ(θ,ϕ), and ideal means μₘ given in Equation (3), provides real-valued weight coefficients, mean, and covariance matrices of the Gaussian functions corresponding to a finite-energy GKP state characterized by input energy parameter E and qubit class of GKP state are as follows:

$$\begin{matrix}{c}_{m} ( ϵ ; θ , ϕ ) = exp [ - \frac{1 - {e}^{- 2 ϵ}}{ℏ ( 1 + {e}^{- 2 ϵ} )} {μ}_{m}^{T} {μ}_{m} ] ; \\ {μ}_{m} ( ϵ ) = \frac{2 {e}^{- ϵ}}{1 + {e}^{- 2 ϵ} )} {μ}_{m} ; and \\ {\sum }_{m} ( ϵ ) = \frac{ℏ}{2} \frac{1 - {e}^{- 2 ϵ}}{( 1 + {e}^{- 2 ϵ} )} ;\end{matrix} \} \qquad Equations ( 4 )$$

Where θ and ϕ are the polar and azimuthal angles of the qubit in the Bloch sphere representation, respectively, [symbol] is an overall normalization constant defined to satisfy the condition of Σ_{m∈M}cₘ=1, n is a Planck's constant, and [symbol] is an identity matrix.

In one aspect, the GKP state as represented by Equations (4) provides a noise model (i.e. mathematically through the spherical angles of the qubit in the Bloch sphere representation) that may track locations of peak values, thereby accounting for the contraction of the Wigner function towards the origin of phase space due to finite energy effects and broadening of each peak in the Wigner function due to finite-energy effects.

In some further embodiments, finite-energy GKP states can be mathematically derived by applying the Fock damping operator Ê(∈) to the qubit's wavefunction of the GKP state to obtain a superposition of squeezed states, and then use this form to calculate the Wigner function directly. This representation differs from the one previously described in two ways. First, the weights and means of the resulting Wigner function are complex rather than real numbers. Second, the covariances of the individual Gaussian functions now respect the uncertainty relation. Since in this representation, each peak is directly mappable to squeezed states in the wave function, it can be more useful for converting effects observed at the wavefunction level to phase space transformations.

For a logical GKP qubit by |ψ(α) [symbol] =α₀|0 [symbol] _{gkp}+α₁|1 [symbol] _{gkp} The parameters from Equation (1) become:

$$\begin{matrix}\begin{matrix}{c}_{m} = exp \{ - \frac{απ}{2} [ {( s + 2 l )}^{2} + \\ {( t + 2 k )}^{2} ] \} \times [ \frac{{β}^{2} {π ( t + s + 2 l + sk )}^{2}}{4 α} ] ;\end{matrix} \\ {μ}_{m} ( ϵ ) = - \frac{β \sqrt{πℏ}}{2} ( \frac{( t + s + 2 l + 2 k )}{\begin{matrix}α \\ i ( s - t + 2 l - 2 k )\end{matrix}} ) ; and \\ {\sum }_{m} ( ϵ ) = \frac{ℏ}{2} ( \begin{matrix}\frac{1}{α} & 0 \\ 0 & α\end{matrix} ) , ( α , β ) = ( coth ( ϵ ) , - csch ( ϵ ) ) ;\end{matrix} \} \qquad Equations ( 5 )$$

Wherein [symbol] ={m ≡(k, l, S, t)|s, t ∈{0,1}&k, l ∈ [symbol] }, [symbol] denotes set of all integers, αₛ is and αₜ are derived from |ψ(α) [symbol] =α₀|0 [symbol] _{gkp}+α₁|1 [symbol] _{gkp}, [symbol] (α, ∈) is an overall normalization constant defined to satisfy the condition of [symbol] =1, n is Planck's constant.

In this embodiment, the Gaussian functions all have the same covariance matrix. While the weight coefficients can be complex, this only stems from the initial qubit coefficients α₀, α₁. The means μₘ(∈) are complex, and the resulting sinusoidal oscillations in phase space generate the interference fringes and negative regions of the Wigner function in this representation.

In some further still embodiments, the finite-energy GKP states are in the form of squeezed comb states. In ideal form, such GKP state has infinitely squeezed position states, or kets. The finite-energy form of such GKP states can be obtained from the ideal GKP states by applying a symmetric step function in the position basis to selectively choose a certain number of the delta function peaks of the qubit in one quadrature of phase space and then replacing the infinitely squeezed position kets with their finitely squeezed states. The wavefunction of the squeezed comb states may be expressed as:

$$\text{?}$$

$$\text{?} \text{indicates text missing or illegible when filed}$$

Where [symbol] is a normalization constant.

$$\text{?}$$

$$\text{?} \text{indicates text missing or illegible when filed}$$

Where qₙ are the locations of the peaks in the position quadrature, and N is the number of peaks in the comb. Hence, the density matrix is given by:

$$\text{?}$$

$$\text{?} \text{indicates text missing or illegible when filed}$$

Using the linearity of the mapping between density operators and Wigner functions, and the derivation of Weyl transform of the outer product of two Gaussian states, the Wigner function may be expressed in the form of Equation (1) with

$$\text{?} \qquad Equations ( 6 )$$

$$\text{?} \text{indicates text missing or illegible when filed}$$

In some embodiments, simulation of GKP state may be carried out based on the input energy parameter (∈ or r), qubit class (i.e. GKP state), and a GKP state representation (i.e. real-valued, complex-valued, or squeezed comb state). The GKP state representation may be prompted as a further input upon detection of a GKP state qubit class, or alternatively, the GKP state representation may form part of the qubit class input. Based on the energy parameter, qubit class, and the GKP state representation, appropriate Equations (4), (5), or (6) are used to determine the weight coefficients, means, and covariance matrices of the Gaussian functions in phase space.

### Cat States

A cat state is defined as the quantum superposition of two opposite-phase coherent states of a single optical mode (e.g., a quantum superposition of large positive electric field and large negative electric field). As is the case with squeezed comb states, cat states are linear superpositions of pure Gaussian states. The density matrix of cat states may be converted from its wavefunction as:

|k^{α} [symbol] [symbol] k^{α}|_{cat}= [symbol] (|α [symbol] [symbol] α|+|−α [symbol] [symbol] −α|+|α [symbol] [symbol] −α|e^{-iπk}+|−α [symbol] [symbol] α|e^{iπk}).

By linearity of the mapping between density operators and Wigner functions, the Wigner functions of the first two terms |+α [symbol] [symbol] +α| are Gaussian functions with the covariance matrix of the vacuum and displacement μ_{±}=±\sqrt{2n}( [symbol] (α), [symbol] (α)). Similar to the derivation of squeezed comb states, the Wigner functions of |α [symbol] [symbol] −α| and |−α [symbol] [symbol] α| are complex-valued Gaussians with prefactor μ_{z}=μ_{z}* Accordingly, the Wigner function of cat states may be expressed as a linear of combinations of Gaussian functions in the form of Equation (1) at step 206 with the following parameters:

$$\begin{matrix}{c}_{\pm } = , {c}_{z} = {( {c}_{\overline{z}} )}^{*} = {e}^{- i π k - 2 {\vert α \vert}^{2}} ; \\ \begin{matrix}{μ}_{\pm } = \pm \sqrt{2 ℏ} ( ( α ) , ( α ) ) , \\ {μ}_{z} = {( {μ}_{\overline{z}} )}^{*} = \sqrt{2 ℏ} ( i ( α ) , - i ( α ) ) ; and\end{matrix} \\ {\sum }_{vac} = \frac{ℏ}{2}\end{matrix} \} \qquad Equations ( 7 A )$$

Wherein +, −, [symbol] , z̅ are indices for the Gaussian functions in phase space corresponding to the four terms from the cat state density matrix such that [symbol] ={+, −, [symbol] , z̅}, [symbol] is a normalization constant that is overall equal to 1, n is Planck's constant, and [symbol] is an identity matrix.

In some embodiments, cat states can also be approximated, to arbitrary precision, by a linear combination of Gaussian functions where the weights, means, and covariance matrices are all real. The trade-off for this real-valued representation is an increase in the number of terms in the linear combination. For approximated cat states, they may be expressed in the form of Equation (1) as follows:

$$\text{?} \qquad Equations ( 7 B )$$

$$\text{?} \text{indicates text missing or illegible when filed}$$

where α ∈ [symbol] _{≠0}, c_{±}, μ_{±}, and Σ_{±} are the same as in Equation (8), and D is a positive real parameter controlling the precision.

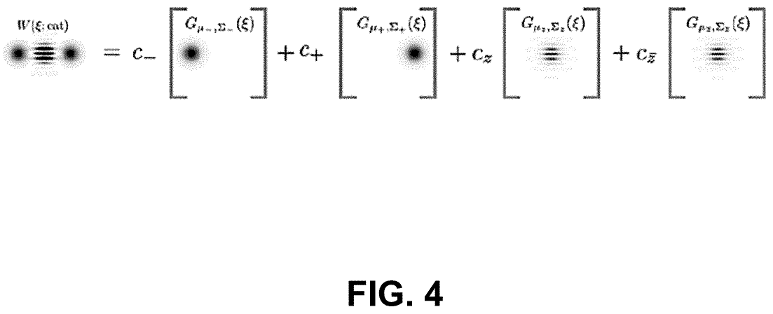

FIG. 4 illustrates a graphical representation of the Wigner function of a cat state being expressed as a linear combination of four Gaussian functions in phase space. In FIG. 4, [symbol] ={+, −, z, z̅} Gaussian functions needed. As shown, the cat state Wigner function W (ζ;cat) is represented as a linear combination of four Gaussian functions each characterized by weight coefficient C applied to a corresponding Gaussian integral G having a mean of μ and a covariance matrix of Σ(ζ).

### Fock States

Fock state is a quantum state corresponding to a well-defined number of particles or quantas or excitations of a CV system. In some embodiments, the Gaussian representation of Fock states is obtained by photon addition where a quantum-optical circuit in which post-selected heralded outcomes in certain ancillary modes permits the application of creation operation of a given mode to an arbitrary input state.

In deriving the Gaussian representation of Fock states, first consider photon addition applied to a vacuum state for the generation of a single photon. The addition of a single photon generally equates to a two-mode squeezing operation S_{0,3}(r)=exp(r[\hat{α}₀^{†}\hat{α}₁^{†t}−\hat{α}₀\hat{α}₁]) with squeezing parameter r<<1 applied to a target mode and to a secondary vacuum state mode, followed by detection of a single photon in the second mode. Mathematically, the operation may be modelled as follows:

$$( {0}_{} ⊗ \vert {1}_{1} 〉 〈 {1}_{1} \vert ) {\hat{S}}_{0 , 1}^{( 2 )} ( r ) ( \vert {ψ}_{0} ) ⊗ \vert {0}_{1} 〉 ) \approx ( {0}_{} ⊗ \vert {1}_{1} 〉 〈 {1}_{1} \vert ) ( + r {\hat{a}}_{0}^{†} {\hat{a}}_{1}^{†} ) ( \vert {ψ}_{0} 〉 ⊗ \vert {0}_{1} 〉 ) = r ( {\hat{a}}_{0}^{†} \vert {ψ}_{0} 〉 ) ⊗ \vert {1}_{1} 〉 ,$$

Where [symbol] ⱼ is the identity operation in the Hilbert space of mode j. If |ψ [symbol] =|0₀ [symbol] is the vacuum state of mode 0, then the state at the output is a single photon in this mode. Since squeezing parameter is such that r<<1, the photon number-resolving detection |1 [symbol] [symbol] 1| is replaced by the approximate version [symbol] −|0 [symbol] 0|, the threshold detection.

It follows then that the probability of successful and failed heralding may be expressed as:

$${p}_{1} = {tr}_{1} ( [ {1}_{} - \vert {0}_{1} 〉 〈 {0}_{1} \vert ] \vert Ψ 〉 〈 Ψ \vert ) = 1 = {p}_{0} , {p}_{0} = \frac{1}{1 + \overline{n}} ,$$

Where |ψ [symbol] =Ŝ_{0,1}(r)|0₀0₁ [symbol] and n̅=sinh^{2r} is the mean photon number in either of the two modes, 0 or 1. The state conditioned on successful heralding with threshold detectors in mode 0 is as follows:

$$\begin{matrix}\vert 1 〉 〈 \vert \approx \text{?} = \frac{{tr}_{1} ( [ {1}_{} - \vert {0}_{1} 〉 〈 {0}_{1} \vert ] \vert Ψ 〉 〈 Ψ \vert )}{{p}_{1}} \\ = \frac{{\hat{ρ}}^{th} - {p}_{0} \vert 〉 〈 0 \vert}{{p}_{1}}\end{matrix} \qquad Equation ( 8 )$$

$$\text{?} \text{indicates text missing or illegible when filed}$$

which is a linear combination of density matrices for two Gaussian states, namely, a thermal state with mean photon number n̅ and the single-mode vacuum. A thermal state with mean photon number

$$〈 {\hat{a}}^{†} \hat{a} 〉 = 〈 \overline{n} 〉 = \overline{n}$$

is a mixed Gaussian state with zero mean and covariance matrix

$$\sum = ℏ ( \overline{n} + \frac{1}{2} )$$

and can be expressed in the Fock basis as:

$$\text{?}$$

$$\text{?} \text{indicates text missing or illegible when filed}$$

where n̅=[e^{∈}−1]⁻¹ or, equivalently,

$${e}^{ϵ} = 1 + \frac{1}{\overline{n}} ,$$

which confirms that \hat{p}₁ in Equation (9) approaches a single photon in the limit of r→0.

The above scheme may be extended to an n-photon addition that provides a Fock state with n photons when applied to the vacuum. Accordingly, in some embodiments, any n-particle Fock state may be approximated using the general notation of Equation (1) with

$$\text{?}$$

$$\text{?} \text{indicates text missing or illegible when filed}$$

Wherein the energy parameter is specified by n, [symbol] ={0, . . . , n}, r is a parameter quantifying the quality of the approximation, m is the index for reach Gaussian function, n is Planck's constant, and [symbol] is an identity matrix.

Although the equations above were derived with the assumption that the squeezing parameter r<<1, and they depend explicitly on this parameter, as long as

$$r < \frac{1}{\sqrt{n}} ,$$

the expressions correspond to a physical state.

Although the above methods are shown, it is understood that other methods of determining the weight coefficients, means, and covariance matrices for GKP state, cat state, and Fock state qubits, or methods of determining the same parameters for any other suitable classes of Bosonic qubits are contemplated.

At 206, simulation of the qubit may be possible by applying transformations of the phase space representations of user specified quantum logic gates and/or measurements as described in more detail below to the phase space representation of the qubit, thereby updating the weight coefficients, means, and covariance matrices of Equation (1). The one or more quantum logic gates and measurements may be received as user input either through input device 106, or through network interface 110, retrieved from a file stored in storage unit 118, or any other suitable methods.

### Gaussian and Non-Gaussian Transformations

A Gaussian unitary transformation Û is equivalent to a homogeneous linear phase-space transformation ζ→S^{T}ζ, followed by a phase-space displacement d by ζ→ζ+d. The symplectic T for Gaussian states, is equivalent to transforming the covariance matrix as Σ→SΣS^{T} and the mean as μ→Sμ. Hence, the displacement transforms the mean as Sμ→Sμ+d. By way of a non-limiting examples, the single-mode displacement and squeezing operators are defined respectively by

$$\text{?}$$

$$\text{?} \text{indicates text missing or illegible when filed}$$

Where a is the phase space displacement parameter, \hat{α}^{†} is the raising or creation operator (the conjugate transpose of the destruction operator), superscript * denotes the complex conjugate, \hat{D} is single-mode displacement operator, and Ŝ is the squeezing operator. In phase space, the two operators are represented as:

$$\text{?}$$

$$\text{?} \text{indicates text missing or illegible when filed}$$

With the assumption that ζ=ζ*=r is real.

A Gaussian channel is a linear completely-positive trace-preserving map from Gaussian states to Gaussian states. Gaussian channels can be described by a pair of real 2n×2n matrices (X,Y) with

$$\text{?}$$

$$\text{?} \text{indicates text missing or illegible when filed}$$

The action or the Gaussian channel described on the characteristic function is as follows:

$$χ ( r ; \hat{ρ} ) \to {χ}^{′} ( r ; \hat{ρ} ) = χ ( Xr ; \hat{ρ} ) exp ( - \frac{1}{2} {r}^{T} {Y}_{r} )$$

It follows that the transformation on the covariance matrix and mean is given by

Σ→X^{T}ΣX+Y,μ→Xμ.

In addition to the mapping provided by (X, Y), a displacement can be added to a Gaussian channel and the transformation will remain deterministic. Deterministic Gaussian transformations modify neither the number nor the weighting of the peaks in the linear combination, which makes them easy to apply to states of the form Equation (1). Specifically, deterministic transformation that are not conditioned on any probabilistic measurement outcomes acting on an n-mode state of the form in Equation (1) can be parameterized, as shown, by two 2n×2n matrices (X,Y), and a length-2n vector d that together transform the covariance matrix and mean of the Wigner function as follows:

Σₘ→XΣₘX^{T}+Y,

μₘ→Xμₘ+d. Equation (10)

A wide class of CV operations, including displacement, squeezing, rotation, and beam-splitter, as well as common noise models, such as loss and Gaussian random displacements, are deterministic transformations.

Conditional transformations, where changes to one or more optical modes, for example from applying a measure, updates the remaining active modes, can apply both conditional Gaussian transformations and non-Gaussian transformations to the Wigner function.

Conditional Gaussians require two sets of modes: set [symbol] of active modes, described initially described initially by a Wigner function in the form of Gaussians in accordance with Equation (1) with weights αₗ, means μₗ, and covariances Σₗ, for l ∈ [symbol] where [symbol] is a first set of indices; and set B of modes that are eventually measured, with corresponding parameters bₖ, μₖ and Σₖ, for k ∈ [symbol] where [symbol] is a second set of indices. When the two sets of modes are entangled via a deterministic Gaussian transformation parametrized by (X,Y,d), the weights, means and covariance of the entangled modes become:

cₘ=αₗbₖ,m=(l,k)∈ [symbol] =( [symbol] ),

μₘ=X(μₗ⊕μₖ)+d,

Σₘ=X(Σₗ⊕Σₖ)X^{T}+Y.

The means and variances may be expressed as:

$${\sum }_{m} = ( \begin{matrix}{\sum }_{m , A} & {\sum }_{m , AB} \\ {\sum }_{m , AB}^{T} & {\sum }_{m , B}\end{matrix} ) , {μ}_{m} = ( \begin{matrix}{μ}_{m , A} \\ {μ}_{m , B}\end{matrix} ) ,$$

where [symbol] and B indicate the active and measured modes, respectively.

For a measurement \hat{M} with outcome Mon modes B with a phase space representation of the form:

$$Φ ( ξ ; \hat{M} ) = {d}_{j} {G}_{{μ}_{j} , {\sum }_{j}} ( ξ ) ,$$

Where Φ is the Weyl transform parametrized by weights dⱼ, means μⱼ, and covariances Σⱼ, with j ∈ [symbol] . Since measurements are described in Hilbert space by a partial trace, which is a linear operation, then the corresponding description in phase space integral is an integral which is a sum of many partial Gaussian integrals G_{μ}_{ⱼ} due to the states and measurements being represented by linear combinations of Gaussian functions. Thus, the covariances and means of modes A update the remaining modes B in accordance with Equation (10) as follows:

Σ_{m,A}→Σ_{m,A}−Σ_{m,AB}(Σ_{m,B}+Σⱼ)⁻¹Σ_{m,AB}^{T},

μ_{m,A}→μ_{m,A}+Σ_{m,AB}(Σ_{m,B}+Σⱼ)⁻¹(μⱼ−μ_{m,B}).

The measurement outcome M occurs with probability:

$$\begin{matrix}p ( M ; \hat{ρ} ) = \int d ξΦ ( ξ ; \hat{M} ) W ( ξ ; \hat{ρ} ) \\ = {c}_{m} {d}_{j} {G}_{{μ}_{m} , {\sum }_{m} + {\sum }_{j}} [ {μ}_{j} ]\end{matrix}$$

With each peak from modes B and the measurement operator contributing differently to the probability, with a weight given by:

w(M\μ_{m,B},Σ_{m,B},μⱼ,Σⱼ)=c_{m,}dⱼG_{μ}_{_{m,B}},Σ_{m,B}+Σⱼ(μⱼ);

Therefore, given the result M, the weight coefficients update as:

$${c}_{m} \to {γ}_{m , j} = \frac{w ( M \vert {μ}_{m , B} , {\sum }_{m , B} , {μ}_{j} , {\sum }_{j} )}{p ( M ; {\hat{ρ}}_{AB} )} , \qquad Equation ( 11 )$$

as normalized by all the new weights. Accordingly, the total number of Gaussians functions in the Wigner function representation for modes [symbol] , as well as their associated weight coefficients, means and covariances, has been increased both by modes B and by the measurement M:

$$ℓ {\to }^{B} m = ( ℓ , k ) {\to }^{M} ( m , j ) = ( ℓ , k , j ) ∈ ( ) ,$$

such that the final number of Gaussian functions required to describe mode [symbol] is the product of the initial number of Gaussian functions in modes [symbol] and B, and in the Weyl transform of \hat{M}.

In some embodiments, conditional dynamics may increase the number of Gaussian functions initially in modes [symbol] , thereby necessarily describing non-Gaussian transformations. The cost of modelling non-Gaussian transformations in accordance with the present disclosure include the number of peaks that need to be considered to increase. However, for certain classes of bosonic qubits, the trade-off is beneficial compared to existing methods in terms of processing speed, computing resources as non-limiting examples.

In embodiments where modes B and the measurement are true Gaussian states (i.e. describable with a single Gaussian function, as opposed to linear combinations of Gaussian functions), then bₖ=dⱼ=1, and ( [symbol] )→ [symbol] . This means the initial number of weights does not increase, and the initial means μₗ and covariances Σₗ follow the traditional Gaussian conditional update rule

Σ_{m,A}→Σ_{m,A}−Σ_{m,AB}(Σ_{m,B}+Σ_{M}⁻¹Σ_{m,AB}^{T},

μ_{m,A}→μ_{m,A}+Σ_{m,AB}(Σ_{m,B}+Σ_{M})⁻¹(T_{M}−μ_{m,B}), Equation (12)

where Σₘ and r_{M} parametrize the Gaussian measurement as:

$$\begin{matrix}p ( {r}_{M ; \hat{ρ}} , {\sum }_{m} ) = \int d ξ W ( ξ ; \hat{ρ} ) ( ξ ) {G}_{{r}_{M} , {\sum }_{M}} ( ξ ) \\ = {\sum }_{m ∈ ℳ} {c}_{m} {G}_{{μ}_{m} , {\sum }_{M} + {\sum }_{m}} ( {r}_{M} )\end{matrix} .$$

With Gaussian peak reweighting as shown in Equation (11), but simplified due to the total number of weight coefficients does not increase and dⱼ=1.

### Gaussian and Non-Gaussian Measurements

Given a state whose Wigner function can be expressed as a linear combination of Gaussian functions in phase space, measurements performed on such CV states may also be correspondingly determined. By way of a non-limiting example, a general-dyne Gaussian detection (or measurement) on n-modes is characterized by the 2n×2n covariance matrix Σₘ of the Gaussian state onto which one projects. The outcome of a general-dyne measurement is a point in phase space, r_{M}. When the Wigner function of a state is expressed as a linear combination of Gaussian functions in phase space in accordance with Equation (1), the probability of outcome r_{M} may be as follows:

$$\begin{matrix}p ( {r}_{M ; \hat{ρ}} , {\sum }_{M} ) = \int d ξ W ( ξ ; \hat{ρ} ) ( ξ ) {G}_{{r}_{M} , {\sum }_{M}} ( ξ ) \\ = {\sum }_{m ∈ ℳ} {c}_{m} {G}_{{μ}_{m} , {\sum }_{M} + {\sum }_{m}} ( {r}_{M} )\end{matrix} .$$

In some embodiments, a measurement of the q-quadrature under homodyne detection (or measurement), a special case of the general-dyne measurement, may be applied, for which

$${\sum }_{M} = {lim}_{q \to 0} \frac{ℏ}{2} ( ) ,$$

the measurement outcome becomes r_{M}→q_{M}. Since the q-homodyne distribution can be retrieved by integrating out the p-quadrature, and since the Wigner function is a linear combination of Gaussian functions in accordance with Equation (1), the outcome is as follows:

$$p ( {q}_{M ; \hat{ρ} M} ) = {c}_{m} {G}_{{μ}_{m}^{( q )} , {\sum }_{m}^{( qq )}} ( {q}_{M} ) .$$

Where μₘ^{(q)} and Σₘ^{(qq)} denote the q-quadrature components of the means and covariances. Notably, the distribution is yet another linear combination of Gaussian functions of a variable in n rather than 2n dimensions.

The method for calculating the probability distribution of a Gaussian measurement can be generalized to a class of non-Gaussian measurements for which the measurement operator can itself be represented in phase space as a linear combination of Gaussian functions. In embodiments where the Weyl transform of a measurement operator \hat{M} associated with outcome M is of the form

$$Φ ( ξ ; \hat{M} ) = {d}_{j} {G}_{{μ}_{j} , {\sum }_{j}} ( ξ ) \qquad Equation ( 13 )$$

Where Φ is the phase space representation of \hat{M} resulting from the Weyl transform, ζ is the phase space variable. The probability of obtaining M is as follows:

$$\begin{matrix}p ( M ; \hat{ρ} ) = \int d ξΦ ( ξ ; \hat{M} ) W ( ξ ; \hat{ρ} ) \\ = {c}_{m} {d}_{j} {G}_{{μ}_{m} , {\sum }_{m} + {\sum }_{j}} [ {μ}_{j} ]\end{matrix} .$$

Loss is the dominant imperfection in the photonics context. By way of a non-limiting example, in some embodiments, loss is modeled as an interaction with a thermal environment through a beam-splitter transformation, resulting in a bosonic Gaussian channel. The strength of the loss parameter of the channel may be set by the beam-splitter angle. The pure loss channel can be described in the form of Equation (10) with the matrix pair

(X_{η},Y_{η})=(\sqrt{η} [symbol] ,(1−η) [symbol] /2)

where η is sometimes referred to as the transmission or transmissivity parameter, and where the environment is assumed to have zero temperature. In some embodiments, thermal loss with covariance matrix

$$ℏ ( n + \frac{1}{2} )$$

may be incorporated by multiplying Y_{η} by (2n̅+1).

The Fock damping or finite-energy operator may be used for converting infinite-energy parameters, such as ideal position and momentum eigenstates and GKP states, into their normalizable, finite-energy forms as described above. In the context of GKP states, the Fock damping operator Ê(∈) can be derived by passing a state through a beam-splitter of transmissivity cos θ=e^{-∈} with an ancillary vacuum state, and post-selecting the ancillary mode on vacuum. For initial means and covariances of a mode of (μ_{m,0},Σ_{m,0}), then the covariance and mean may be expressed as:

$${\sum }_{m} = {S}_{θ} ( \begin{matrix}{\sum }_{m , 0} & 0 \\ 0 & ℏ𝟙 / 2\end{matrix} ) {S}_{θ}^{T} , {μ}_{m} = {S}_{θ} ( \begin{matrix}{μ}_{m , 0} \\ 0\end{matrix} ) ,$$

where

$${S}_{θ} = ( \begin{matrix}cos θ𝟙 & sin θ𝟙 \\ - sin θ𝟙 & cos θ𝟙\end{matrix} )$$

is the symplectic matrix for a beam-splitter assuming a mode-wise ordering (q₁, p₁, q₂, p₂). Update rule in Equation (12) may then be applied, as well as the per-peak reweighting in Equation (11) with dⱼ₌₁, r_{M}=0, and Σ_{M}=n [symbol] /2, since the projection is onto vacuum.

At 208, the updated weight coefficients, means, and covariance matrices of the qubit phase space representation in accordance with Equation (1) may be stored on the classical computer 100 in its storage unit(s) 118 or memory 120. Intermediary measurement outcomes within the quantum circuit characterized by the quantum logic gates and measurements may also be collected vai sampling methods (i.e. for example rejection sampling), and also stored on storage unit(s) 118 and/or memory 120. The updated weight coefficients, means, and covariance matrices may be used to construct the Wigner function of the quantum state, thereby providing the full state information.

### Multi-Mode State Simulation

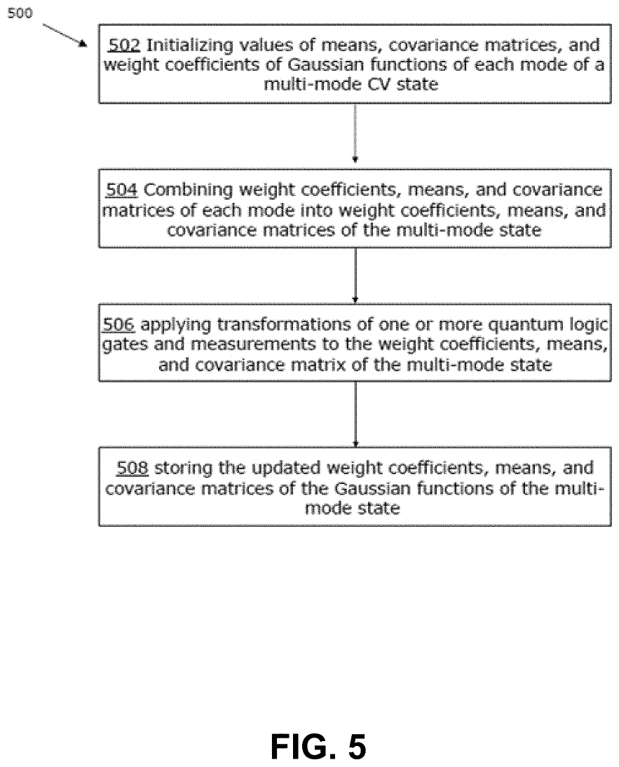

FIG. 5 illustrates a flowchart of a simulation method 500 for simulating a multi-mode (i.e. n-mode) state on a classical computing system 100 in accordance with exemplary embodiments of the present disclosure. Each mode may be described in phase space representation as set out in Equation (1).

At 502, the values of weight coefficients, a vector comprised of means value, and covariance matrices for each mode of a n-mode state are initialized based on energy parameter and qubit class input. In some embodiments, the initial values for each mode may be determined by methods described in step 204 of method 200. In some embodiments, such as GKP and cat states, all of the Gaussian peak values in the linear combination representation of that mode may have the same covariance matrix. Accordingly, only a single covariance matrix may be initialized and tracked so as to increase computing resource efficiency, such as usage of memory 120.

At 504, the initial weight coefficients, means, and covariance matrices for each mode are combined into weights, means, and covariance matrices of the multi-mode state. In some embodiments, the individual mode parameters may be combined as follows:

$$\begin{matrix} & Mode 1 & Mode 2 & & Multimode \\ Weights & {a}_{ℓ} & {b}_{k} & & {a}_{ℓ} {b}_{k} \\ Means & {μ}_{ℓ} & {μ}_{k} & \to & {μ}_{ℓ} ⊕ {μ}_{k} \\ Covariances & {\sum }_{ℓ} & {\sum }_{k} & & {\sum }_{ℓ} ⊕ {\sum }_{k}\end{matrix}$$

Where the multimode weight coefficients may be the product of individual weight coefficients, the multimode means and covariance matrices may be the direct sum of the means and covariance matrices of the individual modes, respectively. In some embodiments, step 504 may be executed recursively from bottom up to derive the weight coefficients, means, and covariance matrices of the full multi-mode initial state.

At 506, each quantum logic gate or measurement in the quantum circuit as specified by user input, are converted to their phase space representations. The transformation associated with the phase space representations are applied to update the weight coefficients, means and covariances of the multi-mode state. Byway of a non-limiting example, in some embodiments, to apply a loss channel, matrices that parametrize the channel in the form of (X_{η},Y_{η})=(\sqrt{η} [symbol] ,(1−η)n [symbol] /2) and applied to Equation (10). In some further embodiments, for a given measurement outcome on a subset of modes, the other modes are updated using Equations (11) and (12).

At step 508, the output of the simulation includes the updated weight coefficients, means, and covariance matrices of the multi-mode state may be stored on the classical computer in its storage unit 118 or memory 120. Intermediary measurement outcomes within the circuit may also be collected via sampling methods, such as rejection sampling, and stored in the storage unit 118 or memory 120. The updated weight coefficients, means, and covariance matrices may then be used to construct the Wigner function of the quantum state, thereby providing the full state information. The intermediary measurement outcomes may provide statistical information about the quantum circuit.

### Simulation Comparison

A comparison of the Gaussian function based simulation with that of the prior art based on the Fock basis, the present method provides one or more advantages in accuracy and computational speed. Consider that the Hamiltonian for a single mode is given by

$$\hat{H} = \frac{1}{2} ( {\hat{q}}^{2} + {\hat{p}}^{2} ) = \frac{1}{2} {\hat{r}}^{2} = ℏ ( \hat{n} + \frac{1}{2} ) .$$

This means that the Wigner function of a Fock state In) has an associated radius in phase space of roughly |rₙ|=\sqrt{n(2n+1)}, beyond which the function decays monotonically. Thus, to determine the Fock representation for a state which has a phase-space Gaussian peak at a point r₀, a conservative estimate has that we would need a photon number of at least

$$n ( {r}_{0} ) \sim \frac{{\vert {r}_{0} \vert}^{2}}{2 ℏ} \qquad Equation ( 14 )$$

to reach the required radius in phase space. Furthermore, Fock states beyond this value may be necessary, for example, to shape the phase space peak for a desired level of squeezing. In the presence of realistic noise sources like loss, the state additionally becomes mixed, requiring a density matrix rather than a state vector representation in the Fock basis, squaring the number of elements which needs to be simulated. For a state with a phase space peak at r₀, the number of elements needs to be simulated in the Fock basis to have a faithful representation of the state scales in the form of

$$\frac{{\vert {r}_{0} \vert}^{2}}{{ℏ}^{2}} .$$

This Fock-basis scaling is compared to expressing the states of interest as linear combinations of Gaussian functions in phase space. The trivial case is a Gaussian state; regardless of its position, orientation, and level of squeezing in phase space, only a 2-component vector of means and a 2×2 covariance matrix needs to be simulated. For an N-mode Gaussian state, the number of elements to simulate scales like 4N²+2N, without exponential scaling since all the modes are represented by a single Gaussian function. Adding a mode with a Gaussian state to a series of other modes with states represented by a linear combination of Gaussian functions only increases the dimension of the covariance matrices and means by 2, but does not change the number of weight coefficients, means or covariance matrices that needs to be simulated.

As disclosed herein, a single-mode two-lobe cat state can be represented using one 2×2 covariance matrix, along with four weight coefficients and 2-component vectors of means—two real-valued and two complex-valued. The size of the mathematical objects required for this representation is independent of the energy of the cat state associated wither, and is invariant under Gaussian transformations. While the covariance for N modes encoded as cat qubits scales like 4N², the number of weights scales exponentially as 4^{N}, and the number of elements in the means grows as 2N(4^{N}). This is still preferable to the Fock basis representation, for which the number of density matrix elements scales as |α|^{4N}; notably, scaling for the linear combination of Gaussians representation does not depend on the energy of the state or modifications under Gaussian transformations. This may be advantageous since, for example, the error rates for some qubit gates on cat states can scale as

$$\frac{1}{\vert α \vert} .$$

achieve low error rates, the energy of the cat state must be increased.

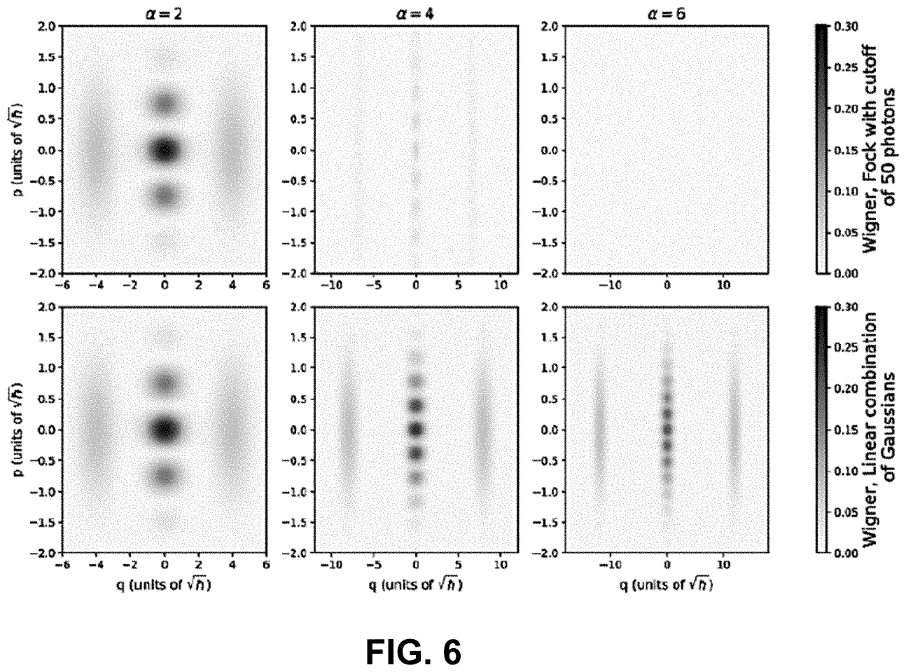

FIG. 6 illustrates comparison of the simulation results of two cat states simulated in Fock basis and Gaussian representation, respectively, sent through a lossy beam-splitter. For the Fock basis simulation, the Wigner function of one of the modes is plotted for increasing values of energy, as parametrized by a. The Fock basis simulation uses a photon number cut-off of 50 photons per mode since going beyond this value saturates the memory of a classical computing system used for simulation, such as a standard desktop terminal. The same states are also represented as linear combinations of Gaussian functions in phase space in accordance with embodiments of the present disclosure. As shown, for α=2, the Fock basis representation simulation results are compared with that of the Gaussian representation simulation. However, it was observed that the Fock basis simulation required more memory and longer execution time when simulating the lossy beam-splitter. Insufficiencies of the Fock basis simulation becomes more apparent for cases of α=4 and 6. For these increased values of a, the action of the beam-splitter leads to Gaussian peaks in phase space at distances of 8\sqrt{n}and 12\sqrt{n}, from the phase space origin, respectively, requiring, by the conservative estimate in Equation (14), greater than 32 and 72 photons for each case. Although n=32 is within the cut-off of 50 photons, the Fock representation simulation still cannot accurately construct the Wigner function for α=4 since Equation (14) is a conservative estimate and likely to be underestimating the required photon number cut-off in that case.

As described with respect to Equations (14), even Fock states of n photons can be approximated by n real-valued weights, n 2×2 covariance matrices, and one 2-component vector of means. Simulation of such Fock states may be more memory-intensive than representing a pure number state in the Fock basis; however, under Gaussian transformations such as displacements or squeezing, or the common loss channel, representing the Fock state by a linear combination of Gaussians may still become advantageous overall.

While GKP states may have an infinite number of peaks, only a finite number of peaks need to be simulated since the weight coefficients in Equations (4) decay exponentially under the Fock damping operator. As the Fock damping operator decays exponentially in Fock space, an analogous procedure can be executed to establish a reasonable photon number cut-off. A single-mode GKP state may be approximated by a finite number of peaks, with the furthest peak located near

$$\frac{\sqrt{π}}{2} ( k , l ) ,$$

then the number of peaks that need to be simulated scales as k²+l², and consequently so does the number of elements for the vectors of means; by contrast, only a single 2×2 covariance matrix is required for the simulation. Compare this with the Fock basis representation, where, by Equation (14), the number of density matrix elements scales as (k²+l²)². For N modes encoded as GKP states, its simulation would require (k²+l²)^{N} weight coefficients and means, and a single 2N×2N covariance matrix, an improvement over the (k²+l²)^{2N} scaling for the number of density matrix elements in the Fock basis simulation.

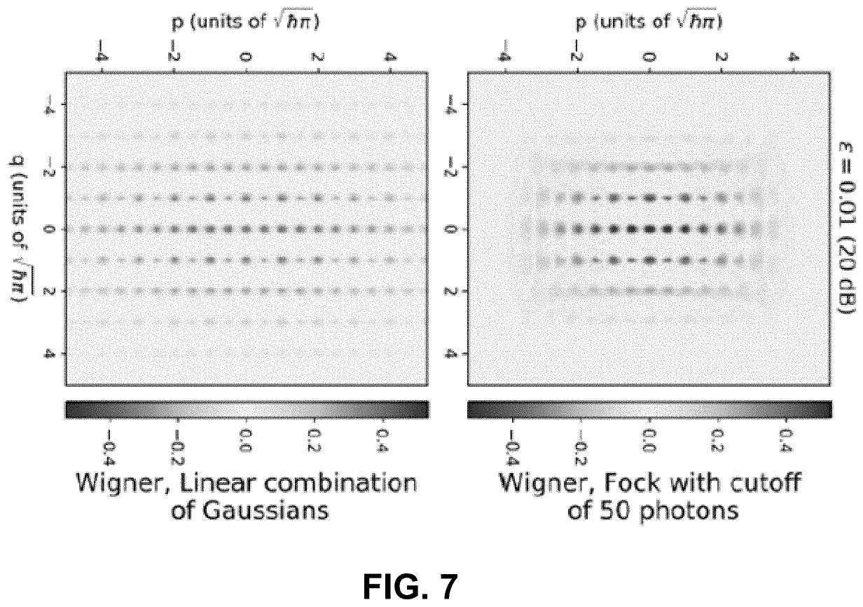

To illustrate the advantage of the Gaussian function based simulation, FIG. 7 shows plots of the Wigner function for the output mode of a simulated CV teleportation of a high-energy GKP state (∈=0.01, corresponding to 20 dB of per-peak squeezing) onto a p-squeezed state with 15 dB of squeezing using a lossy CZ gate, homodyne measurement, and feedforward displacement. As shown in FIG. 7, the Fock basis simulation is limited in the radius of phase space that it can accurately capture, while the Gaussian function-based simulation produces all peaks correctly. Moreover, the all-Gaussian nature of the teleportation circuit allows for more efficient computation, when representing the states as linear combinations of Gaussian functions over the Fock basis representation, which requires many tensor contractions for large density matrices.

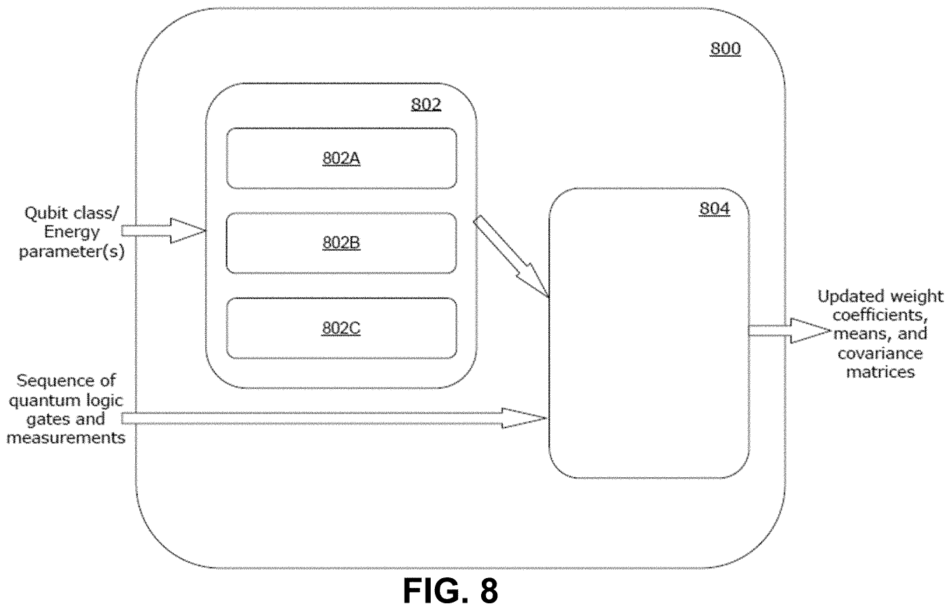

FIG. 8 illustrates a simplified block diagram of a simulator system 800 for simulating qubits on a classical computer in accordance with exemplary embodiments of the present disclosure. The simulator system 800 can be a module that is implemented by a combination of machine-readable instructions executable on a processing system. As used here, a “module” can refer to a combination of a hardware processing circuit and machine-readable instructions (software and/or hardware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

Storage devices (i.e. storage units 118 and/or memory 120) store machine-readable software instructions that are executable by one or more processing units 102 for implementing a Gaussian function based quantum simulator system 800 that allows users or clients to define, create, and simulate one or more quantum states. The simulator system 800 may be implemented within a single (or standalone) computing system 100, or alternatively, the simulator system 800 may also be embodied across multiple computing systems 100 interconnected over a network.

As shown in FIG. 8, simulator system 800 includes a Gaussian function constructor 802 which receives energy parameter(s) and bosonic qubit class(es) or type(s) (i.e. GKP, cat, Fock, etc.) of bosonic qubit(s) to be simulated as input. The Gaussian function constructor determines at least one Gaussian functions in phase space, each of which is characterized by a weight coefficient, a mean, and a covariance matrix. The weight coefficient, mean, and covariance matrix of each of the at least one Gaussian functions may be combined, for example as a linear combination, to approximate the qubit to be simulated in accordance with embodiments of the present disclosure described herein. In some embodiments, the linear combination of the Gaussian functions of a n-mode CV state is of the form shown in Equation (1).

In the illustrated embodiment, the Gaussian function constructor 802 includes sub-module GKP state constructor 802A for determining the weight coefficients, means, and covariance matrices of Equation (1) for bosonic qubits whose qubit class is of a GKP state. In some embodiments, the Gaussian function parameters are determined in accordance with Equations (4). Alternatively, the GKP state Gaussian function parameters of Equation (1) may also be determined in accordance with Equations (5) when the GKP state qubit is finitized by applying a Fock damping operator to its wavefunction. Further still, in embodiments where the finite-energy GKP state qubit is in the form of squeezed comb state, the Gaussian function parameters of Equation (1) may be determined in accordance with Equations (6).

In the illustrated embodiment, the Gaussian function constructor 802 includes sub-module cat state constructor 802B for determining the weight coefficients, means, and covariance matrices of Equation (1) for bosonic qubits whose qubit class is of a cat state. In some embodiments, the weight coefficients, means, and covariance matrices of Equation (1) are determined in accordance with Equations (7A). In some further embodiments, the Gaussian function parameters of an approximated cat state having real-valued weight coefficients, means, and covariance matrices may be determined in accordance with Equations (7B).

In the illustrated embodiment, the Gaussian function constructor 802 further includes sub-module Fock state constructor 802C for determining the weight coefficients, means, and covariance matrices of Equation (1) for bosonic qubits whose qubit class is of a Fock state. In some embodiments, the weight coefficients, means, and covariance matrices of Equation (1) are determined in accordance with Equations (9).

Further submodules may be included for additional bosonic qubit classes where appropriate.

The quantum simulator system 800 further includes a Gaussian function transformer 804, which may carry out step 208 of method 200. The Gaussian function transformer receives the sequence of quantum logic gates and measurement as input. Each quantum logic gate is converted to its phase space representation, and the logic gate phase space representations are applied as transformations to the weight coefficients, means, and covariance matrices of the linear combination of Gaussian functions of the qubit. Each measurement is also converted into its phase space form and applied to the phase space representation of the qubit. Each measurement may provide a measurement outcome, either user-defined or using sampling algorithm, and updates the weight coefficients, means, and covariance matrices of the phase space representation of the qubit in the form from Equation (1).

The Gaussian function transformers 804 provides, as its output, the measurement outcomes from all the measured qubits as well as the final updated weight coefficients, means, and covariance matrices of the phase space representation of the qubit in the form from Equation (1). The outputs may be used to further determine all the measurement statistics of a simulated quantum circuit with one or several bosonic qubits. Further the final updated weight coefficients, means, and covariance matrices may be used to plot the Wigner function of the final qubit states.

It should be understood that the sub-modules 802A, 802B, and 802C, as well as Gaussian function constructor 802 and Gaussian function transformer 804, are not necessarily separate units of the system 800, and that the illustration of the modules 802, 804, and submodules 802A, 802B, and 802C as separate blocks within the system 800 may only be a conceptual representation of the overall operation of the system 800.

Although the present disclosure may describe methods and processes with steps in a certain order, one or more steps of the methods and processes may be omitted or altered as appropriate. One or more steps may take place in an order other than that in which they are described, as appropriate.

Although the present disclosure may be described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for simulating a quantum bit (qubit) on a classical computer, the method comprising:
obtaining, by the classical computer, an energy parameter and a qubit class of the qubit to be simulated;
determining, by the classical computer from the energy parameter and the qubit class, a mean, a covariance matrix, and a weight coefficient for each of at least one Gaussian function in phase space, wherein a linear combination of the at least one Gaussian function is a phase space representation of the qubit to be simulated;
simulating the linear combination of the at least one Gaussian function by applying transformations of quantum logic gates and measurements to update the weight coefficient, mean, and covariance matrix of each of the at least one Gaussian function; and
storing the updated weight coefficient, mean, and covariance matrix of each of the at least one Gaussian function on the classical computer.

2. The method of claim 1, wherein the qubit is a bosonic qubit.

3. The method of claim 2, wherein the qubit class includes Gottesman-Kitaev-Preskill (GKP) state, cat state, and Fock state.

4. The method of claim 1, further comprises constructing a Wigner function of the qubit from the updated weight coefficient, mean, and covariance matrix of each of the linear combination of the Gaussian functions.

5. The method of claim 1, further comprises sampling outcomes of the linear combination of the at least one Gaussian function.

6. The method of claim 1, wherein the linear combination of Gaussian functions is:
$$W ( ξ ; \hat{ρ} ) = {c}_{m} {G}_{{μ}_{m} {\sum }_{m}} ( ξ )$$
wherein W is a Wigner function of the of the qubit, [symbol] is the set of indices enumerating the Gaussian functions, ζ∈ [symbol] ²ⁿ is a phase space variable for an n-mode continuous variable (CV) quantum system, \hat{ρ} is a density matrix operator in Hilbert space that is representative of the energy parameter and the qubit class of the qubit, cₘ is the weight coefficient, μₘ is the mean, and Σₘ is the covariance matrix, and G is a normalized multivariate Gaussian distribution function.

7. The method of claim 1, wherein the qubit class is a GKP state, the obtaining further comprises receiving a GKP state representation.

8. The method of claim 7, wherein the GKP state representation is a real-valued GKP state, the weight coefficient, mean, and covariance matrix of each of the at least one Gaussian function are determined by:
$${c}_{m} ( ϵ ; θ , ϕ ) = exp [ - \frac{1 - {e}^{- 2 ϵ}}{ℏ ( 1 + {e}^{- 2 ϵ} )} {μ}_{m}^{T} {μ}_{m} ] ;$$
$${μ}_{m} ( ϵ ) = \frac{2 {e}^{- ϵ}}{1 + {e}^{- 2 ϵ} )} {μ}_{m} ; and$$
$${Σ}_{m} ( ϵ ) = \frac{ℏ}{2} \frac{1 - {e}^{- 2 ϵ}}{( 1 + {e}^{- 2 ϵ} )} 𝟙 ;$$
Where the energy parameter is specified by ∈, θ and ϕ are the polar and azimuthal angles of the qubit in the Bloch sphere representation, [symbol] is an overall normalization constant defined to satisfy a condition of as Σ_{m∈M}cₘ=1, n is Planck's constant, and [symbol] is an identity matrix.

9. The method of claim 7, wherein the GKP representation is a complex-valued GKP state, the weight coefficient, mean, and covariant matrix of each of the at least one Gaussian function are determined by:
$${c}_{m} = exp \{ - \frac{α π}{2} [ {( s + 2 l )}^{2} + {( t + 2 k )}^{2} ] \} \times [ \frac{{β}^{2} {π ( t + s + 2 l + s k )}^{2}}{4 α} ] ;$$
$${μ}_{m} ( ϵ ) = - \frac{β \sqrt{πℏ}}{2} ( \begin{matrix}\frac{( t + s + 2 l + 2 k )}{α} \\ i ( s - t + 2 l - 2 k )\end{matrix} ) ; and$$
$${Σ}_{m} ( ϵ ) = \frac{ℏ}{2} ( \begin{matrix}\frac{1}{α} & 0 \\ 0 & α\end{matrix} ) , ( α , β ) = ( coth ( ϵ ) , - csch ( ϵ ) ) ;$$
Where the energy parameter is specified by ∈, [symbol] ={m≡(k, l, s, t)|s,t ∈ {0,1}&k,l ∈ [symbol] }, [symbol] denotes set of all integers, αₛ is and αₜ are derived from |ψ(α) [symbol] =α₀|0 [symbol] _{gkp}+α₁|1 [symbol] _{gkp}, [symbol] (α,∈) is an overall normalization constant defined to satisfy the condition of [symbol] cₘ=1, n is Planck's constant.

10. The method of claim 7, wherein the GKP representation is a squeezed comb state, the weight coefficient, mean, and covariant matrix of each of the at least one Gaussian function are determined by:
$$= \{ m ≡ ( k , l ) \vert k , l ∈ 1 … , d \} ,$$
$${μ}_{m} = \frac{1}{2} ( {\overline{q}}_{k} + {\overline{q}}_{l} , i {ϵ}^{2 r} [ {\overline{q}}_{k} - {\overline{q}}_{l} ] ) ,$$
$${\sum }_{m} = \frac{ℏ}{2} [ \begin{matrix}{e}^{- 2 r} & 0 \\ 0 & {e}^{2 r}\end{matrix} ]$$
$${e}_{m} = exp ( - \frac{1}{4 ℏ} {{e}^{2 r} ( {\overline{q}}_{k} - {\overline{q}}_{l} )}^{2} ) .$$
Where [symbol] is a normalization constant, qₙ are the locations of the peaks in the position quadrature where
$${\overline{q}}_{n} = - ( N + 1 ) \frac{d}{2} + nd ,$$
and N is the number of peaks in the comb.

11. The method of claim 1, wherein the qubit class is a cat state, the weight coefficient, mean, and covariant matrix of each of the at least one Gaussian function are determined by:
$${c}_{\pm } = , {c}_{z} = {( {c}_{\overline{z}} )}^{⋆} = {e}^{- i π k - 2 {\vert α \vert}^{2}} ;$$
$${μ}_{\pm } = \pm \sqrt{2 ℏ} ( ( α ) , ( α ) ) ,$$
$${μ}_{z} = ( {μ}_{\overline{z}} ) = \sqrt{2 ℏ} ( i ( α ) , - i ( α ) , ) ; and$$
$${\sum }_{vac} = \frac{ℏ}{2} .$$
Wherein the energy parameter is specified by α, +, −, [symbol] , z̅ are indices for the Gaussian functions in phase space corresponding to the four terms from the cat state density matrix such that [symbol] ={+, −, [symbol] , z̅}, [symbol] is an overall normalization constant defined to satisfy the condition of [symbol] (∈; θ,ϕ)=1, n is Planck's constant, and [symbol] is an identity matrix.

12. The method of claim 1, wherein the qubit class is a Fock state, the weight coefficient, mean, and covariant matrix of each of the at least one Gaussian function are determined by:
$${c}_{m} = ( \begin{matrix}n \\ m\end{matrix} ) [ \frac{1 - {nr}^{2}}{1 - ( n - m ) {r}^{2}} ] ;$$
$${μ}_{m} = 0 ; and$$
$${Σ}_{m} = \frac{ℏ}{2} \frac{1 + ( n - m ) {r}^{2}}{1 - ( n - m ) {r}^{2}} ;$$
Wherein the energy parameter is specified by n, [symbol] ={0, . . . , n}, r is a parameter quantifying the quality of the approximation, [symbol] is the index fro reach Gaussian function, [symbol] is an overall normalization constant defined as
$$= \frac{n ! ( n ( \frac{- {r}^{2} - 1}{{r}^{2}} ) ! + ( - \frac{1}{{r}^{2}} ) ! )}{( \frac{n {r}^{2} - 1}{{r}^{2}} ) !} ,$$
n is Planck's constant, and [symbol] is an identity matrix.

13. A method of simulating a multi-mode quantum state on a classical computer, the method comprising:
obtaining, by the classical computer, an energy parameter and a qubit class of each mode of the multi-mode quantum state to be simulated;
initializing, by the classical computer from the energy parameter and the qubit class, a mean, covariance matrix, and a weight coefficient of at least one first Gaussian function of each mode in phase space, wherein a linear combination of the at least one first Gaussian function is a phase space representation of a mode of the multi-mode quantum state;
combining the weight coefficient, mean, and covariance matrix of the at least one first Gaussian function of each mode into weight coefficients, means, and covariance matrices of at least one second Gaussian function, wherein a linear combination of the at least one second Gaussian function is a phase space representation of the multi-mode quantum system;
simulating the multi-mode quantum system by updating the weight coefficients, means, and covariance matrices of the at least one second Gaussian function by applying transformations of quantum logic gates and measurements expressed in phase space; and
storing the updated weight coefficients, means, and covariance matrices of the at least one second Gaussian function of the multi-mode quantum system on the classical computer.

14. The method of claim 13, wherein the combining further comprises recursively combining the weight coefficient, mean, and covariance matrix of the at least one first Gaussian function into the weight coefficients, means, and covariance matrices of the at least one second Gaussian function of the multi-mode quantum system.

15. The method of claim 13, when the qubit class is GKP state or cat state, wherein the initializing further comprises initializing one covariance matrix for the at least one first Gaussian function.

16. The method of claim 13, wherein the combining further comprises:
combining the weight coefficients as a product of two weight coefficients;
combining the means as a direct sum of two means; and
combining the covariance matrix as a direct sum of two covariance matrices.

17. The method of claim 13, where in the linear combination of the at least one first Gaussian function and the linear combination of the at least one second Gaussian function are of the form:
$$W ( ξ ; \hat{ρ} ) = {c}_{m} {G}_{{μ}_{m} {\sum }_{m}} ( ξ )$$
wherein W is a Wigner function of the of the qubit, [symbol] is the set of indices enumerating the Gaussian functions, ζ∈ [symbol] ²ⁿ is a phase space variable for an n-mode continuous variable (CV) quantum system, \hat{ρ} is a density matrix operator in Hilbert space that is representative of the energy parameter and the qubit class of the qubit, cₘ is the weight coefficient, μₘ is the mean, and Σₘ is the covariance matrix, and G is a normalized multivariate Gaussian distribution function.

18. A system for simulating a quantum bit (qubit) on a classical computer, the system comprises:
a Gaussian function constructor configured to determine, using inputs of an energy parameter and a qubit class, a mean, a covariance matrix, and a weight coefficient for each of at least one Gaussian function in phase space, wherein a linear combination of the one Gaussian function is the phase space representation of the qubit to be simulated; and
a Gaussian function transformer configured to simulate the qubit by applying transformations of quantum logic gates and measurements to the linear combination of the at least one Gaussian function on the classical computer, thereby updating the weight coefficient, mean, and covariance matrix of each of the at least one Gaussian function.

19. The system of claim 18, wherein the Gaussian function constructor is further configured to determine the linear combination of the at least one Gaussian function in phase space are of the form:
$$W ( ξ ; \hat{ρ} ) = {c}_{m} {G}_{{μ}_{m} {\sum }_{m}} ( ξ )$$
wherein W is a Wigner function of the of the qubit, [symbol] is the set of indices enumerating the Gaussian functions, ζ∈ [symbol] ²ⁿ is a phase space variable for an n-mode continuous variable (CV) quantum system, \hat{ρ} is a density matrix operator in Hilbert space that is representative of the energy parameter and the qubit class of the qubit, cₘ is the weight coefficient, μₘ is the mean, and Σₘ is the covariance matrix, and G is a normalized multivariate Gaussian distribution function.

20. A non-transitory machine-readable medium having tangibly stored thereon executable instructions for execution by a processor of a classical computer, wherein the executable instructions, when executed by the processor, cause the classical computer to:
obtain, by the classical computer, an energy parameter and a qubit class of the qubit to be simulated;
determine, by the classical computer from the energy parameter and the qubit class, a mean, a covariance matrix, and a weight coefficient for each of at least one Gaussian function in phase space, wherein a linear combination of the at least one Gaussian function is a phase space representation of the qubit to be simulated;
simulate the linear combination of the at least one Gaussian function by applying transformations of quantum logic gates and measurements to update the weight coefficient, mean, and covariance matrix of each of the at least one Gaussian function; and
store the updated weight coefficient, mean, and covariance matrix of each of the at least one Gaussian function on the classical computer.
